(19) United States
(12) Patent Application Publication
(10) Pub. No.: US 2007/0215225 A1
(43) Pub. Date: Sep. 20, 2007

(54) Valve arrangement for a gas installation

(75) Inventors: Jurgen Koch, Attendorn (DE); Robert Zink, Hagen (DE); Norbert Gartner, Frankfurt/Main (DE)

Correspondence Address: K.F. ROSS P.C., 5683 RIVERDALE AVENUE, SUITE 203 BOX 900, BRONX, NY, 10471-0900, US

(73) Assignee: ISPHORDING Germany GmbH

(21) Appl. No.: 11/710,871

(22) Filed: Feb. 26, 2007

(30) Foreign Application Priority Data
Feb. 27, 2006 (DE) 102006009496.4

(51) Int. Cl. F16K 11/22

(52) U.S. Cl. 137/883

(57) ABSTRACT

The invention relates to a valve arrangement for a gas installation comprising a valve body with at least one gas inlet, whereby at least one gas outlet is assigned to a gas inlet and, more particularly whereby one gas outlet can be closed by means of a medium-controlled or flame-controlled safety valve element, whereby one gas outlet be reduced in cross-section and/or closed by means of a valve element arranged on a non-rotating shaft, whereby the actuator (6) of the valve element (10) is in the form of a linear motor (6) on the shaft of which the valve element (10) is directly arranged. The invention also relates to a joint valve body for multiple adjacent identical valve arrangements in which the gas inlets (3) of all valve arrangements are connected to a joint gas pipeline (3) more particularly extending in the longitudinal direction of the entire valve body (1), whereby perpendicularly to the axis of the joint gas supply pipeline (3) bored holes (B1-B5) are arranged, which at least from holders for safety valve arrangements (2) and actuators (6) as well as gas outlets (5), more particularly also for forming a by-pass pipeline (18), in which, more particularly, a gas nozzle (19) can be used.

The invention relates to a valve arrangement for a gas installation comprising a valve body with at least one gas inlet, whereby at least one gas outlet is assigned to a gas inlet and whereby one gas outlet can be reduced in cross-section and/or closed by means of a valve element arranged on a non-rotating shaft.

Such a valve arrangement can also comprise a safety device which has a safety valve element with which a gas inlet can be media-controlled and/or flame-controlled. Such a safety device is usually designed as a passive, i.e. not self-attracting magnetic valve, which is held open by the current of a thermoelement arranged in or near a flame. If the flame is extinguished the magnetic valve automatically closes off further gas supply due to lack of the required holding current.

A valve arrangement of this type is disclosed, for example, in EP 0 875 720. A drawback of this embodiment is the fact that the actuator is designed as a conventional electric motor with a rotating shaft, the rotation of which is converted by way of gearing and/or a clutch provided between the electric motor and the valve body, into a straight-line movement of a second shaft on which a simple flat valve disk is arranged.

The gearing and/or clutch is created in that the second shaft, bearing the valve plate, is connected to a nut which is borne on a rotating shaft, which in turn is connected to the rotating shaft of the actuator. This produces a structurally complex valve arranged with considerable sealing problems between the valve body and the clutch/gearing on the one hand and between the clutch/gearing and motor on the other hand.

Furthermore, the known valve arrangement is not suitable for fine regulation of the gas flow between a gas inlet and a gas outlet.

The aim of the invention is to create a valve arrangement of the type set out in the introduction, more particularly one with a safety valve, which is simple in design, has no sealing problems and, in particular, also provides fine regulation of the gas flow.

This objective is achieved in accordance with the invention in that the actuator of the valve element is designed as a linear motor, on the shaft of which the valve element is directly arranged.

By using a linear motor as the actuator in such a valve arrangement there is no necessity to convert a rotational movement of a shaft into an straight-line movement as the linear motor already provides a straight-line movement of its shaft relative to the casing of the linear motor. The known clutch/gear arrangement can thus be fully dispensed with, as a result of which there are fewer sealing problems and/or tightness can be achieved with simpler measures.

For example, the linear motor can be attached directly on/in the valve body so that essentially only this transition area has to be sealed, e.g. by way of an O-ring seal.

The design is also considerably simplified in that the valve element, which acts in conjunction with a valve seat in order to alter/close the cross-section of a gas channel to the gas outlet, can be arranged directly on the shaft of the linear motor without the intermediate arrangement of a clutch or gearing.

There are no further sealing measures, particularly if in a preferred embodiment the linear motor is designed to be gas-tight. Due to this then given inherent tightness any sealing measures are limited to the above-described measures between the motor and valve body.

Highly satisfactory or absolute tightness can, for example, be achieved in an advantageous embodiment if the shaft is guided in a gas-tight manner in a form-fitting sleeve of the linear motor, more particularly whereby the shaft of the linear motor has a cross section deviating from the round form, and is, more particularly, star-shaped. Through this cross-section particular rotation inhibition is achieved as well as a greater sliding surface.

The high degree of tightness can be achieved in that such a sleeve is longer than conventional O-rings. For example, it can be located in the stroke length of such a linear motor. Preferably a sleeve can be made of Teflon which has excellent sliding properties and also has sealing properties during compression.

A linear motor of this type thus acts as an actuator and at the same time also as a sealing stopper in order to close the drilled hole provided to accommodate it.

It is also possible to arrange an additional, more particularly sleeve-shaped sealing element on a preferably round shaft of the linear motor, having, for example, two O-rings and sealing the shaft vis-à-vis the valve body.

In order to achieve very fine regulation of the valve arrangement in accordance with the invention, a further embodiment can envisage that the valve element is conical in shape. In this case is narrows in its direction of movement to the valve seat, so that, in particular if, preferably, the linear motor is designed as step motor, regulation can be achieved by way of a higher control unit to control the step motor.

In this way in a preferred embodiment the volumetric flow of the gas can be linearly altered depending on the step number of the linear motor, which allows a user to conveniently regulate the gas flow. If the linearity between the step number and the gas flow is not already given by the shape adaptation between the valve element and the valve seat, computer-assisted linearization in a control unit can be carried out.

In a first embodiment it can be envisaged that the valve element is movably arranged on the shaft in a force or spring-actuated manner in the direction of advance, whereby the valve element is pushed by the force against a stop located at the start of the shaft, which, for example, can be a securing ring. In this way the valve element is carried with the shaft in the direction of the valve seat until the valve element rests on the valve element. However, after the valve element is on the valve seat the shaft can continue to be pushed through the valve element.

This can be envisaged, for example, to lift the safety valve element from its valve seat, thereby opening the gas inlet and allowing gas to flow through a by-pass opening e.g. to ignite or maintain a flame, e.g. a pilot or auxiliary flame in low-performance operation (simmer flame). A by-pass opening of this type can for example be arranged between the valve seats of the safety valve element and valve element.

The safety valve element can, as described above, be kept in its open position until the flame goes out.

When the flame is ignited the shaft can be pulled back, e.g. initially into a position in which only the above-described flame is lit. If the shaft is retracted further the stop at the start of the shaft reaches the valve element and this is lifted against the force, which can, for example, be produced by a spring, from the valve seat so that gas can flow through the gas outlet in order, for example, to ignite a main flame or to increase the quantity of gas for the initially lit flame, particularly if the above by-pass opens into the gas outlet.

The-positions the shaft has to occupy for the above settings can, for example, be stored by the assigned step number in the higher control unit.

In a further embodiment the valve element can also be attached in an unmovable manner to the forward end of the shaft, e.g. by screwing onto the shaft. In this case the valve element is always carried with the shaft when it moves and the shaft cannot be used to lift the valve element from its seat. In this embodiment the safety valve element can be actively placed in its open position, i.e. for example by an external power supply or other measures. For example, it can be part of an active magnetic valve which does not only keep the open position but can itself lift the safety valve element from the seat.

For example, in this way the gas can reach a by-pass which, as mentioned above, can be between the valve seats or, for example be designed so that the valve element has at least one by-pass opening, i.e. it never closes completely. Thus, after lifting the safety valve element from its seat gas can always flow through the valve element to the gas outlet.

A by-pass can also be absent, whereby a pilot and/or auxiliary and/or low-performance flame can be -produced through the valve element being raised a predetermined distance from the valve seat by way of- the linear motor, which is preferably controlled by a predetermined number of steps, or possibly just one step.

Usually it is envisaged that, for example, in cooker hobs several gas burners are used. Each burner should/must have a safety device that stops the supply of gas if the flame goes out, and each burner should usually be regulated. Thus several above-described valve arrangements are can be individually used in such an application.

In a particularly preferred embodiment it can be envisaged that the above valve arrangement is arranged in at least twos in a joint valve body, e.g. corresponding to the number of gas burners used on a cooker hob, whereby in the case of a burner with two gas rings two valve arrangements for one burner can be provided.

This simplifies the design considerably as only one single valve body has to be manufactured into which all elements can be integrated . It can preferably also be envisaged that the gas inlets of all valve arrangements are connected to a joint gas supply pipe more particularly extending in the longitudinal direction of the joint valve body.

The design of the valve body described below can not only be selected in the case of multiple adjacent arrangement of similar/identical valve arrangements, but also if only one valve arrangement is envisaged in the valve body.

It is a design advantage if the valve body, more particularly the joint valve of several valve arrangements is in the form of an extruded profile, especially whereby the joint gas supply pipe is integrated into the valve body during the extrusion process.

Equally, the gas supply pipe can be subsequently incorporated into the valve body as a drilled hole. The valve body can also be produced as a cast component. The preferred material is aluminum in each case, though other materials can also be used.

It is also a design advantage if, perpendicularly to the axis of a, more particularly, joint gas supply pipe for a valve arrangement, bored holes are provided for each valve arrangement, which at least form holders for a safety valve arrangement and an actuator and for a gas outlet, in particular also to form a by-pass pipe in which a gas nozzle can be used. These bored holes can be easily incorporated after the manufacture of a blank for the valve body e.g. CNC-controlled.

The bored hole for a safety valve element (active or passive) can be arranged opposite the bored hole for an actuator, more particularly a linear motor, and run axially thereto, i.e. both bored holes lie on one axis. Through these bored holes the valve seats of the above-described valve and safety valve element can be produced at the same time.

A bored hole for each gas outlet can be arranged above a bored hole for an actuator, whereby, more particularly the bored holes are arranged at an angle of 0 to 45 degrees. A gas outlet hole can also be provided above a bored hole for a safety valve element with the same possible angles. Particularly through the parallelism/small angle between the bored holes a particularly flat construction of the valve body is achieved both when producing only one valve arranged as well as several adjacently arranged valve arrangements.

The above design of the valve body can not only be used in conjunction with the described invention of the linear motor and/or the conical valve element, but fundamentally with all types of actuators and valve elements, more particularly those not described here.

Forms of embodiment of the invention are described below:

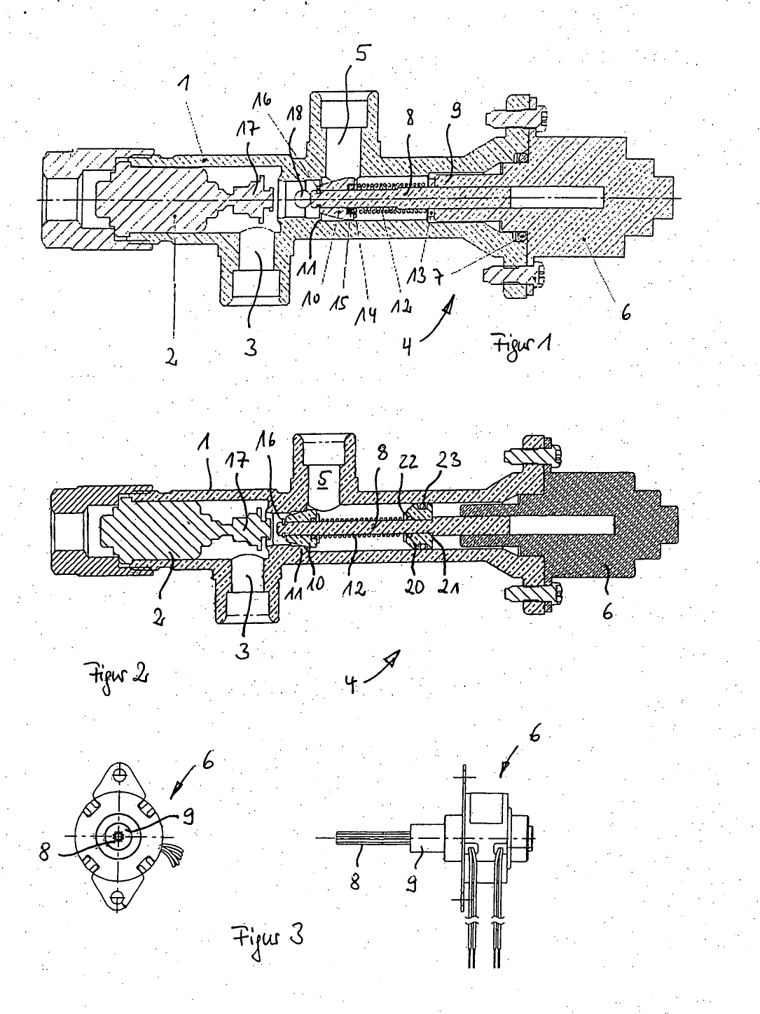

FIG. 1 shows a cross-section through an individual valve arrangement;

FIG. 2 shows a cross-section through an individual valve arrangement with a sealing element arranged on the shaft of the linear motor;

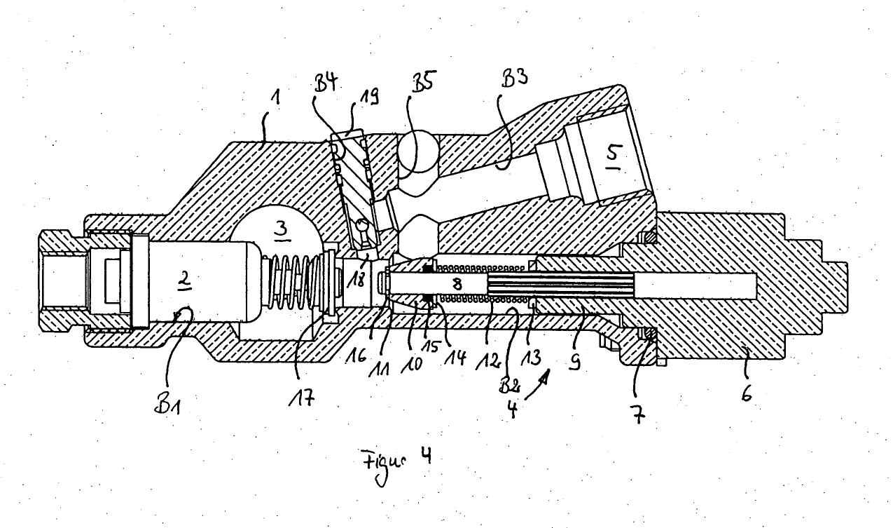

FIG. 3 shows a linear motor; and

FIG. 4 shows a cross-section through a valve arrangement with one or with several identical valve arrangements a joint valve casing.

FIG. 1 shows a cross-section of an individual valve arrangement in accordance with the invention. Shown is a valve body 1 integrated into which from two opposite sides is a safety valve arrangement 2 for opening and closing a gas inlet 3, as well as valve arrangement 4 for opening, closing and regulating a gas flow from gas inlet 3 to a gas outlet 5. Both valve arrangements 2 and 4 are arranged co-linearly opposite each other so that the valves seats are also arranged in parallel to each other.

The valve arrangement 4 is formed here by a linear motor 6 which via an O-ring 7 is attached in a tight manner to the valve body 1. The linear motor 6 has a shaft 8, which is axially movable in a rotation-inhibited manner and slides in a sleeve-shaped projection 9 of the linear motor. The cross-section of the shaft 8 is star-shaped here. FIG. 3 shows two views of a linear motor as use here.

In the embodiment in FIG. 1 a valve element 10 is arranged at the forward end of the shaft 8, can be moved on the shaft 8, sealed by an O-ring 15 and is conical in shape. i.e. tapering towards the valve seat 11. Arranged around the shaft 8 is a pressure spring 12 which is supported on the one hand by a disk 13 on the linear motor (on the sleeve 9) and on the other hand by a disk 14 on the valve element 10.

In this way a force is exerted on the valve element 10 in the direction of advance (to the valve seat) and it rests on a stop 16 at the start of the shaft.

If the shaft 8 is now moved forward by the linear motor 6 the valve element 10 stops at its seat and on further movement of the shaft is pressed by spring pressure against the seat.

By way of the shaft 8 that can be moved through the valve element 10, the safety valve element 17 of the safety valve arrangement 2 can be pressed back so that the gas inlet opens.

Gas can then flow out from the gas inlet 3 to a by-pass bored hole 18 and can be ignited as a pilot, auxiliary or simmer flame. Through the ignited flame a retaining current is produced to keep the safety valve arrangement 2 in the retracted position. By moving the shaft back, after the stop 16 has come into contact with the valve element 10, the valve element is now lifted from its seat 11 and the gas path to the gas outlet 5 is cleared. A main flame can be ignited or the already lit flame can be supplied with more gas if the by-pass 18 opens into the gas outlet 5.

Through the conical/tapered shaped of the valve element 10 very fine regulation of the gas flow results, particularly if the linear motor is a step motor and is controlled electronically.

FIG. 2 shows an embodiment essentially as in FIG. 1, but whereby in this case on the preferred round shaft 8 a sealing element 20 is arranged, which rests on a step 21 on the shaft 8 and is thus carried along with a movement of the shaft 8.

The spring 12 which in. FIG. 1 rests on the casing of the linear motor 6, here rests on the sealing element 20.

In this embodiment the sealing element 20 has two sealing rings, of which sealing ring 22 seals the sealing element vis-à-vis the shaft 8 and of which sealing ring 23 seals vis-à-vis the bored hole in which the linear motor with its shaft 8 is inserted. Thus, the entire area to the right of the sealing element 20 is sealed against the gas. For this reason the sealing ring 7 described in FIG. 1 between the linear motor and the valve body 1 can be omitted.

FIG. 4 shows an embodiment in which several identical valve arrangements are, as described in FIG. 1, arranged consecutively parallel to the plane of the page in a joint valve body 1.

This arrangement can also be selected if only one valve arrangement is required in the valve body, whereby the described gas supply pipe then only supplies one gas inlet.

The valve body is, for example, a cast component or an extruded profile from one block and has one joint gas inlet 3, produced during manufacturing or subsequently, for all the valve arrangements, which as a channel-shaped gas supply pipeline runs through the entire joint valve body 1 perpendicularly to the plane of the page.

Perpendicularly thereto and this in the plane of the page there are bored holes B1 to B5 for each/for one valve arrangement. The bored hole B1 is for taking up a safety valve arrangement, as described above. B2 is for a linear motor 6, whereby B1 and B2 are co-linear. B3 is a bored hole for forming a gas outlet 5 and runs at a slight angle of approx. 20 degrees to B2. Bored hole B3 intersects a bored hole 4 which forms a by-pass and opens into the space between the two valve seats of the safety valve arrangement 2 and the valve arrangement. B3 intersects a bored hole B5 in order to create a connection to bored hole B2 when the valve is open, i.e. the valve element 10 is lifted from the seat 11. After producing bored hole B5 it can be closed.

In bored hole B4 a gas nozzle 19 is used so that gas can flow from the gas inlet via this nozzle to bored hole B5. The gas nozzle 19 simultaneously closes bored hole B4 to the outside.

The front end of the channel for the gas inlet 3 can be connected to a gas pipeline, e.g. the mains supply or a gas bottle. The rear open end is subsequently closed if it has been produced at all during manufacture.

Apparent here is the very flat construction of the valve arrangement(s) in accordance with the invention in a, more particularly, joint valve body, as well as the simply designed assembly which can be achieved by machining a valve body blank.

1. A valve arrangement for a gas installation comprising a valve body with at least one gas inlet, whereby at least one gas outlet is assigned to a gas inlet and, more particularly whereby one gas outlet can be closed by means of a medium-controlled or flame-controlled safety valve element, whereby one gas outlet can be reduced in cross-section and/or closed by means of a valve element arranged on a non-rotating shaft, characterized in that the actuator (6) of the valve element (10) is in the form of a linear motor (6), on the shaft (8) of which the valve element (10) is directly arranged.

2. The valve arrangement in accordance with claim 1, characterized in that the linear motor (6) is gas tight.

3. The valve arrangement in accordance with claim 1, is characterized in that on the shaft (8) of the linear motor (6) a sealing element (20) is arranged, which, more particularly, can incorporate two O-rings (22, 23).

4. The valve arrangement in accordance with claim 1, characterized in that the shaft (8) of the actuator (6) slides in a form-fitting sleeve (9) and, mote particularly, has a cross-section deviating from the round form, more particularly a star-shaped cross section, with the sleeve, more particularly, being made of Teflon.

5. The valve arrangement in accordance with claim 1, characterized in that the valve element (10) is conical.

6. The valve arrangement in accordance with claim 1, characterized in that the linear motor (8) is in the form of a step motor.

7. The valve arrangement in accordance with claim 1, characterized in that the volumetric flow of the gas can be linearly altered in dependence on the step of the linear motor (6).

8. The valve arrangement in accordance with claim 1, characterized in that the valve element (10) is arranged on the shaft (8) in a moveable manner, with a force, more particularly a spring force exerted on it, whereby after the valve element (10) comes to rest on its valve seat (11) the shaft (8) can be pushed through the valve element (10) in order to lift the safety valve element (17) from its valve seat.

9. The valve arrangement in accordance with claim 1 characterized in that the valve element (10) in attached to the forward end of the shaft (8) in an unmovable manner.

10. The valve arrangement in accordance with claim 1, characterized in that the valve element has at least one by-pass drilled hole.

11. The valve arrangement in accordance with claim 1, characterized in that the safety valve arrangement is adjustable in its open position.

12. The valve arrangement in accordance with claim 1 characterized in that it is arranged in multiples in a joint valve body (1).

13. The valve arrangement in accordance with claim 12, characterized in that the gas inlets (3) of all valve arrangement are connected to a joint gas supply pipe, more particularly extending in the longitudinal direction of the joint valve body.

14. The valve arrangement in accordance with claim 1, characterized in that the valve body (1), more particularly the joint valve body (1) of several valve arrangements is formed as an extruded profile, more particularly whereby the gas supply pipe (3) is integrated into the joint valve body (1) during the extrusion process.

15. The valve arrangement in accordance with claim 1, characterized in that perpendicular to the axis of a gas supply pipeline (3) there are bored holes (B1-B5) which at least form holders for a safety valve arrangement (2) and an actuator (6) as well as a gas outlet (5), more particularly also for forming a by-pass pipeline (18) in which a gas nozzle (19) can be used.

16. The valve arrangement in accordance with claim 1, characterized in that a bored hole (B3) for a gas outlet (5) is arranged above a bored hole (B2) for an actuator (6), whereby, more particularly, the bored holes (B2, B3) are arranged at an angle of 0 to 45 degrees.

17. A joint valve body for multiple adjacent identical valve arrangements, more particularly in accordance with claim 1, characterized in that the gas inlets (3) of all valve arrangements are connected to a joint gas supply pipeline (3) more particularly extending in the longitudinal direction of the valve body (1), whereby, more particularly, perpendicular to the axis of the joint gas supply pipe (3), bored holes (B1-B5) are arranged which at least form holders for safety valve arrangements (2) and actuators (6) as well as gas outlets (5), more particularly also for forming a by-pass pipeline (18) in-which, more particularly, a gas nozzle (19) can be used.
